(19) United States
(12) Patent Application Publication
(10) Pub. No.: US 2005/0283572 A1
(43) Pub. Date: Dec. 22, 2005

(54) Semiconductor integrated circuit and power-saving control method thereof

(76) Inventor: Yuzo Ishihara, Tokyo (JP)

Correspondence Address: RABIN & BERDO, P.C.;Suite 500, 1101 14th Street, Washington, DC, 20005, US

(21) Appl. No.: 11/118,343

(22) Filed: May 2, 2005

(30) Foreign Application Priority Data
Jun. 16, 2004 (JP) 2004-178781

(51) Int. Cl. G06F 12/00; G06F 12/14

(52) U.S. Cl. 711/118

(57) ABSTRACT

A semiconductor integrated circuit has an SDRAM and a group of elements, whose power consumption is controlled (referred to as “power-controlled block”). The power-controlled block includes a CPU and a memory control circuit. A power control circuit outputs a power-down signal to an output-fixing circuit when a power-saving mode setting command is supplied from the CPU. A control signal for commanding self-refresh operation is generated from the output-fixing circuit to the SDRAM. The power control circuit thereafter stops the supply of power to the entire power-controlled block in response to a power control signal. When a restart signal is provided, the power control circuit starts the supply of power to the power-controlled block. A power-saving mode release command is then generated from the CPU to the power control circuit, and the power-down signal is stopped. Thereupon, the output-fixing circuit provides a control signal generated from the memory control circuit directly to the SDRAM.

### BACKGROUND OF THE INVENTION

1. Field of the Invention

The present invention relates to a semiconductor integrated circuit having a DRAM (Dynamic Random Access Memory) and power-saving control method thereof.

2. Description of the Related Art

A semiconductor integrated circuit and power-saving control method are known in the art, and examples are disclosed in Japanese Patent Kokai (Laid-open Application) Nos. 2001-357672 and 2003-131935.

A system LSI (Large Scale Integration) is usually provided with a CPU (Central Processing Unit) for carrying out computational routines and controlling the entire system on the basis of a program, a ROM (Read Only Memory) in which programs and other fixed information are stored, a small-capacity RAM (Random Access Memory) for high-speed writing in the stack area and other locations of the OS (Operating System), a large capacity DRAM for storing application programs and intermediate processing data, and I/O (Input/Output) devices. Among the above components, the CPU, ROM, RAM, and I/O devices are connected to the system bus, and the DRAM is connected to the system bus by way of a DRAM control circuit.

Power consumption increases as the system LSI has a larger scale and is operated at a higher speed. Various proposals have been made to reduce power consumption of the system LSI. Mainstream conventional methods for reducing power consumption include stopping the clock in circuit areas not required by the OS and application programs, and dynamically optimizing the operating frequency of the CPU in accordance with the processing load of the program.

With the miniaturization of semiconductor integrated circuits and the increase in the operating frequency in recent years, it has become impossible to ignore the off-leak current of transistors in the CPU and other components, and the ratio of current consumption during inactivity with respect to overall current consumption has increased. For this reason, it is impossible to adequately reduce power consumption of the system LSI by simply reducing the current consumption during operation with the conventional approaches, i.e., stopping the clock and optimizing the operating frequency.

### SUMMARY OF THE INVENTION

One object of the present invention is to provide a method for thoroughly reducing the power consumption of a semiconductor integrated circuit. In particular, the present invention aims at reducing power consumption of a semiconductor integrated circuit having a DRAM.

According to a first aspect of the present invention, there is provided an improved semiconductor integrated circuit. This semiconductor integrated circuit includes a DRAM which performs a self-refresh operation in response to a first control signal. The semiconductor integrated circuit also includes a power-controlled block that has a CPU and a DRAM control circuit. The semiconductor integrated circuit also includes a power control circuit. The power control circuit outputs a power-down signal and stops the supply of power to the power-controlled block when a power-saving mode command is provided by the CPU. When a restart signal is provided from outside during output of the power-down signal, the power control circuit starts the supply of power to the power-controlled block, and stops the output of the power-down signal in accordance with a command from the CPU. The semiconductor integrated circuit also includes an output-fixing circuit connected between the memory control circuit and the DRAM. The output-fixing circuit directly passes on to the DRAM a second control signal generated from the memory control circuit when the power-down signal is not being generated. The output-fixing circuit supplies the first control signal to the DRAM instead of the second control signal when the power-down signal is being generated.

The DRAM, the power control circuit, and the output-fixing circuit are designed to operate under main power, and other circuits, including the CPU and DRAM control circuit, are partitioned as a power-controlled block.

In such a semiconductor integrated circuit, when the reset condition of the power control circuit is released, the supply of power to the power-controlled block is started and the reset condition of the power-controlled block is released. The CPU determines the state of the power-down signal generated from the power control circuit when the power supply is started. If the power-down signal is not being generated, an application program is started.

If a power-down signal is being generated, a DRAM self-refresh start command is issued to the memory control circuit so as to stop output of the power-down signal from the power control circuit and issue a command for releasing the DRAM self-refresh operation to the memory control circuit, thereby resuming the application program.

When the application program has been suspended, a DRAM self-refresh start command is issued to the memory control circuit and a command is provided to the power control circuit to stop the supply of power to the power-controlled block. If a restart signal is externally provided when the supply of power to the power-controlled block is stopped, power supply to the power-controlled block is resumed, the reset condition is released, and operation is started.

In the present invention, there are a power control circuit which, when a command to enter the power-saving mode is issued by a CPU, stops the supply of power to the power-controlled block including the CPU after a power-down signal has been generated, and an output-fixing circuit for outputting a control signal to the DRAM upon receiving the power-down signal with the level of the control signal fixed to a level that designates the self-refresh operation. Power supply to the power-controlled block having a broad range of components, including the CPU, the DRAM control circuit, and the like but excluding the power control circuit, the output-fixing circuit, and the DRAM, can thereby be stopped in the power-saving mode, and power consumption can be thoroughly reduced.

According to a second aspect of the present invention, there is provided a power-saving control method for the semiconductor integrated circuit. The power-saving control method includes a startup routine for starting the supply of power to the power-controlled block, and releases the reset state of the power-controlled block to start operation when the reset state of the power control circuit is released. The power-saving control method also includes a determination routine for determining the state of the power-down signal when the supply of power has been started in the power-controlled block, and starting up an application program if no power-down signal is being generated. A self-refresh start command of the DRAM is issued to the memory control circuit if a power-down signal is being generated. The power-saving control method also includes a resume routine for stopping the output of the power-down signal to the power control circuit, subsequent to the output of the self-refresh start command in the determination routine. A command for releasing the self-refresh operation of the DRAM is issued to the memory control circuit to resume the application program. The power-saving control method also includes a stop routine for issuing a self-refresh start command of the DRAM to the memory control circuit and instructing the power control circuit to stop supplying power to the power-controlled block when the processing of the application program has been interrupted. The power-saving control method also includes a restart routine for resuming the supply of power to the power-controlled block in accordance with an externally provided restart signal, and releasing the reset state of the power-controlled block to start operation when the supply of power to the power-controlled block is stopped.

These and other objects, aspects and novel characteristics of the present invention will become more apparent to those having an ordinary skill in the art by reading and understanding the following detailed description and appended claims with reference to the attached drawings. It should be noted that the drawings are entirely for description only, and do not limit the scope of the present invention.

### BRIEF DESCRIPTION OF THE DRAWINGS

FIG. 1A is a schematic diagram of a semiconductor integrated circuit showing an embodiment of the present invention;

FIG. 1B illustrates a circuit diagram of an output-fixing circuit in FIG. 1A;

FIG. 2 is a flowchart that shows the power control method applied to the semiconductor integrated circuit of FIG. 1; and

FIG. 3 is a signal waveform diagram showing the operation of the circuit of FIG. 1.

### DETAILED DESCRIPTION OF THE INVENTION

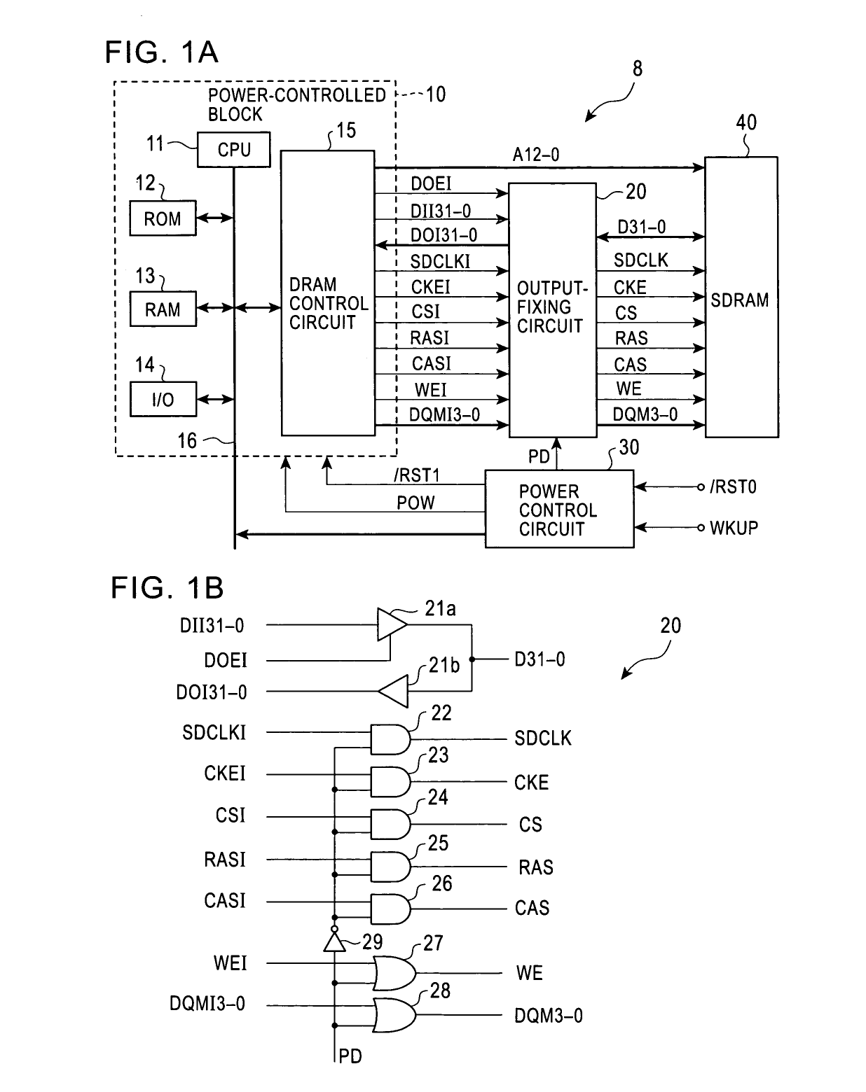

Referring to FIG. 1A and FIG. 1B, a semiconductor integrated circuit 8 according to an embodiment of the present invention will be described.

As shown in FIG. 1A, the semiconductor integrated circuit 8 has a power-controlled block 10 that is designed to be powered off in the power-saving mode, an output-fixing circuit 20 that is not designed be powered off, a power control circuit 30 that is not designed be powered off, and an SDRAM (Synchronous DRAM) 40 that is not designed be powered off. The SDRAM 40 is connected to the output-fixing circuit 20. Because the stored content would be lost if the power is shut off, the SDRAM 40 is not designed to be powered off. However, the SDRAM 40 is able to retain the stored content with low power by specifying a self-refresh operation when reading and writing access is not required.

Included in the power-controlled block 10 are a CPU 11 that controls the entire system and performs computational routines, a ROM 12 in which programs such as the OS executed by the CPU 11 at system startup are stored, a small-capacity RAM 13 for high-speed reading and writing, an I/O device 14, and a DRAM control circuit 15 for controlling the SDRAM 40. These components are connected to each other by way of the system bus 16.

The power supplied to the power-controlled block 10 is switched on or off by the power control signal POW sent by the power control circuit 30. Specifically, when the power control signal POW is at a high level H, a prescribed power voltage is supplied to the components in the power-controlled block 10, and when the power control signal POW is at a low level L, the power voltage is cut off and the supply is completely stopped. A reset signal /RST1 (where the symbol “/” refers to inverted logic) for returning the components to their initial state is sent from the power control circuit 30 to the power-controlled block 10.

The output-fixing circuit 20, which is inserted between the DRAM control circuit 15 and the SDRAM 40, outputs a control signal that commands the self-refresh operation to the SDRAM 40 when the power-saving mode is set by the power-down signal PD issued from the power control circuit 30. It should be noted that the address signals A12 to 0 generated from the DRAM control circuit 15 are directly passed on to the SDRAM 40; they do not pass through the output-fixing circuit 20.

The detail of the output-fixing circuit 20 is shown in FIG. 1B. The output-fixing circuit 20 has buffers 21a and 21b. The write data lines DII31 to DII0 (data bus) and read data lines DOI31 to DOI0 (data bus) extending from the DRAM control circuit 15 are connected to the buffers 21a and 21b, and the two lines extending from the buffers 21a and 21b are connected as data lines D31 to D0 (bidirectional bus) to the SDRAM 40. It should be noted that the buffer 21a is a tristate buffer, and the output to the SDRAM 40 of the write data DII31 to DII0 is controlled by the data output control signal DOEI.

The output-fixing circuit 20 also has AND (logical multiply) gates 22 to 26. For these gates, a clock signal SDCLKI, a clock control signal CKEI, a chip select signal CSI, a row address select signal RASI, and a column address select signal CASI, issued from the DRAM control circuit 15 respectively, are provided as first inputs. The output-fixing circuit 20 also has OR (logical add) gates 27 and 28. For these gates, the write control signal WEI and the data output mask signals DQMI3 to DQMI0, respectively, are provided from the DRAM control circuit 15 as first inputs.

The power-down signal PD is sent from the power control circuit 30 to the second inputs of the OR gates 27 and 28, and the power-down signal PD is inverted by the inverter 29 and sent to the second inputs of the AND gates 22 and 26. A clock signal SDCLK, a clock control signal CKE, a chip select signal CS, a row address select signal RAS, a column address select signal CAS, a write control signal WE, and data output mask signals DQM3 to DQM0 are supplied from the AND gates 22 to 26 and the OR gates 27 and 28 to the SDRAM 40.

Because of this configuration, the clock signal SDCLKI and other signals of the DRAM control circuit 15 are directly sent to the SDRAM 40 as the clock signal SDCLK and other signals when the power-down signal PD is at a low (L) level, i.e., when a normal operation mode is indicated. When the power-down signal PD has a high (H) level indicating the power-saving mode, a control signal commanding the self-refresh operation, that is to say, the low level of the clock signal SDCLK, clock control signal CKE, chip select signal CS, row address select signal RAS, and a column address select signal CAS, and the high level of the write control signal WE and data output mask signals DQM3 to DQM0 are supplied to the SDRAM 40 irrespective of the output of the DRAM control circuit 15.

The power control circuit 30 is designed to send a power control signal POW and a reset signal /RST1 to the power-controlled block 10, and to send the power-down signal PD to the output-fixing circuit 20. The power control circuit 30 is connected to the CPU 11 by way of the system bus 16, and receives the reset signal /RST0 and restart signal WKUP from an external terminal.

The power control circuit 30 has a function for raising the power control signal POW and reset signal /RST1 from a low level to a high level in a prescribed sequence when the reset signal /RST0 or the restart signal WKUP has changed from a low level to a high level. The power control circuit 30 also has a function for setting the power-down signal PD to a high level, and the power control signal POW and reset signal /RST1 to a low level, when a power-saving mode setting command has been sent by way of the system bus 16, and a function for setting the power-down signal PD to a low level when a power-saving mode release command has been sent. It should be noted that the state of the power-down signal PD can be read by the CPU 11 by way of the system bus 16.

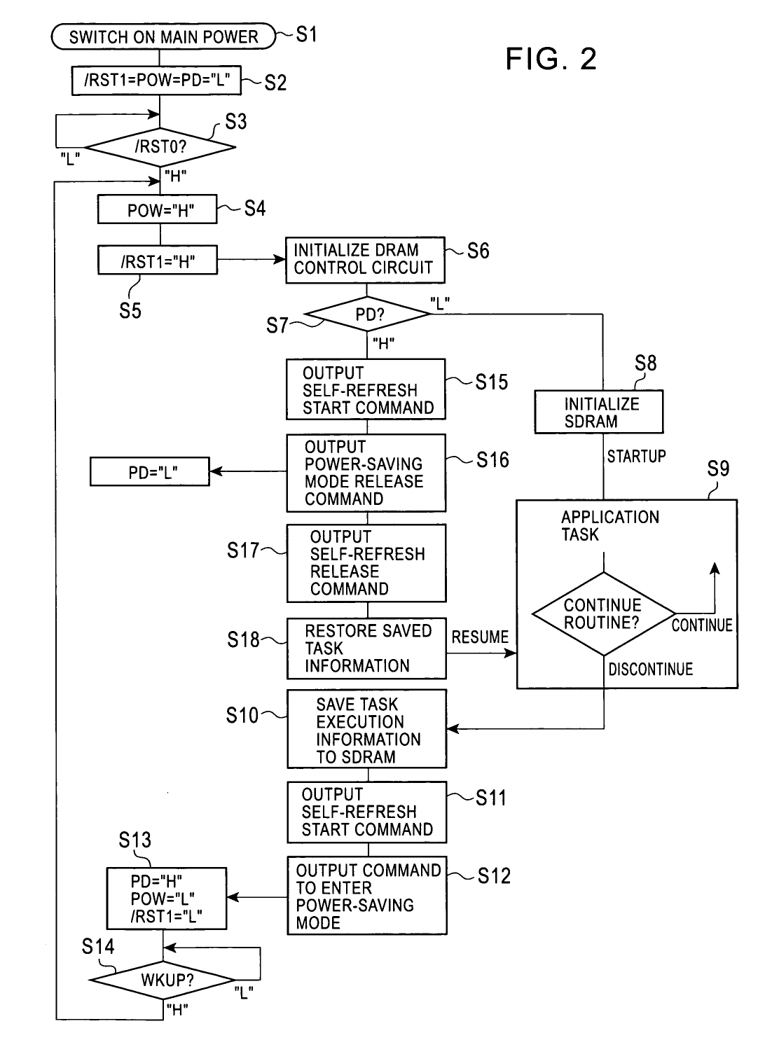

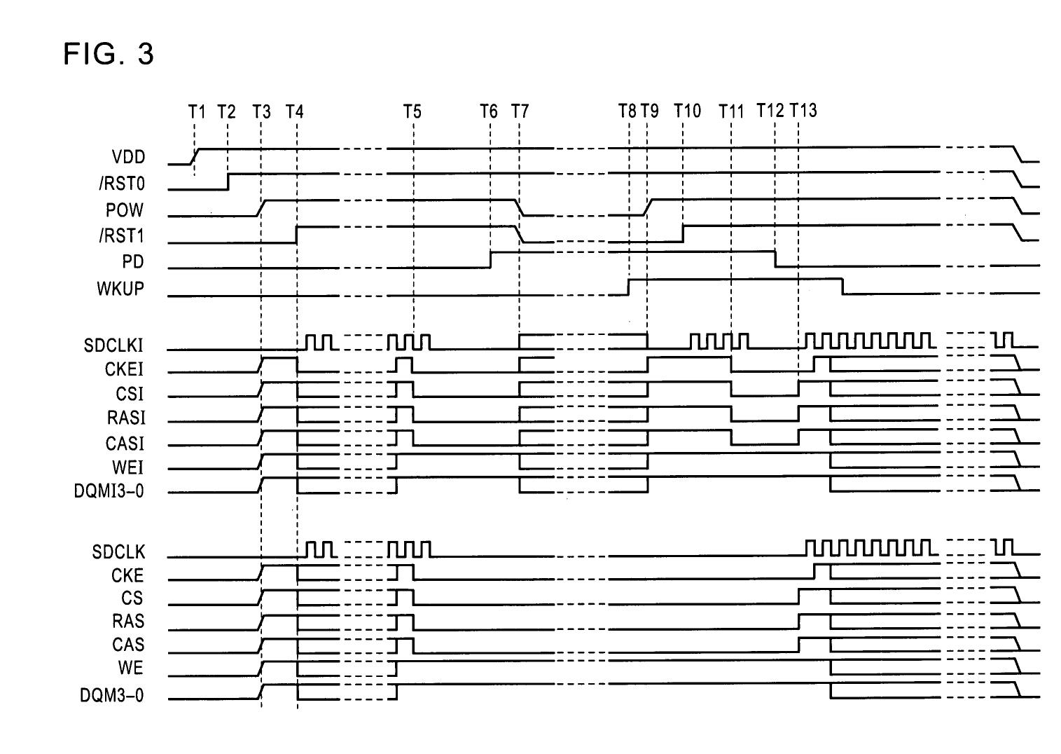

FIG. 2 is a flowchart that shows the power control method applied to the semiconductor integrated circuit 8 of FIG. 1A. In FIG. 2, the operation of the power control circuit 30 is shown in the left hand column, and the operation carried out by the OS and the application program in the CPU 11 of the power-controlled block 10 is shown in the center and right hand columns. FIG. 3 is a signal waveform diagram showing the operation of the semiconductor integrated circuit 8 shown in FIG. 1A. The power control operation of the semiconductor integrated circuit 8 is described below with reference to FIGS. 2 and 3.

When the main power is switched on in step S1 of FIG. 2, that is to say, when the supply of main power VDD to the power control circuit 30 is started at time T1 of FIG. 3, the reset signal /RST1, the power control signal POW, and the power-down signal PD supplied from the power control circuit 30 are all set to a low level, as shown in step S2.

The release of the reset signal /RST0 is monitored in step S3. The reset signal /RST0 is set to a high level by the operation of a power-on reset circuit (not shown) at time T2, for example.

In step S4, once the reset signal /RST0 has reached a high level, the power-down signal PD is set to a high level at time T3 in which a prescribed time has elapsed. The supply of power to the power-controlled block 10 is thereby started, and control signals generated by the DRAM control circuit 15 are activated. Since the power-down signal PD at this time is at a low level, the control signals generated by the DRAM control circuit 15 are sent directly to the SDRAM 40. However, the reset state of the power-controlled block 10 at this time has not been released, and normal operation is therefore not carried out.

In step S5, the reset signal /RST1 is set to a high level at time T4, and the reset state of the power-controlled block 10 is released so that the power-controlled block 10 begins the startup from an initial state. In step S6, the DRAM control circuit 15 is also initialized. In the subsequent step (step S7), the level of the power-down signal PD is determined. If the level is low the system advances to step S8, and if the level is high the system advances to step S15.

In step S8, precharging, refreshing, and other power-on initialization routines are carried out to the SDRAM 40 from the DRAM control circuit 15, and the SDRAM 40 is brought to an operable state.

In step S9, application programs are loaded into the SDRAM 40 and the execution of tasks is started. The SDRAM 40 is accessed by executing the tasks. This condition is maintained while the CPU 11 continues to carry out application program routines, but when awaiting an input or at other times (i.e., when CPU processing is not required), task execution is suspended and the system advances to the power down routine in step S10 and thereafter.

In step S10, the CPU 11 saves to the SDRAM 40 task execution information (context) and other data that reside in the RAM 13 and other memory, in other words, information required for restarting tasks.

In step S11, the CPU 11 issues a self-refresh start command to the DRAM control circuit 15. At time T5, the DRAM control circuit 15 outputs the clock signal SDCLKI, the clock control signal CKEI, the chip select signal CSI, the row address select signal RASI and the column address select signal CASI at a low level, and also outputs the write control signal WEI and data output mask signals DQMI3 to DQMI0 at a high level, on the basis of the self-refresh start command. The signals are supplied directly to the SDRAM 40 by way of the output-fixing circuit 20, and the SDRAM 40 is set in a self-refresh state.

In step S12, the CPU 11 outputs a power-saving mode setting command to the power control circuit 30.

In step S13, the power control circuit 30 sets the power-saving mode on the basis of the power-saving mode setting command. First, at time T6, the power-down signal PD is set to a high level. Thus, the control signals issued from the output-fixing circuit 20 to the SDRAM 40 are fixed to the level that commands self-refreshing irrespective of the control signals generated in the DRAM control circuit 15. Next, at time T7, the power control signal POW and reset signal/RST1 are set to a low level. As a result, the supply of power to the power-controlled block 10 is completely cut off, thereby entering the power-saving mode. It should be noted that power to the output-fixing circuit 20, power control circuit 30, and SDRAM 40 is not cut off, and the SDRAM 40 can therefore self-refresh with low power consumption, and the information stored therein is retained.

The system thereafter advances to step S14, and the restart (wakeup) signal WKUP is monitored by the power control circuit 30. The state of the power-saving mode is maintained while the restart signal WKUP is at a low level. When the restart signal WKUP changes to a high level at time T8, the system moves to step S4 and restart is begun by switching on the power as described above.

In step S4, the power supply signal POW is set to a high level at time T9. In step S5, the reset signal /RST1 is set to a high level at time T1. In step S6, the DRAM control circuit 15 is initialized. In step S7, the level of the power-down signal PD is determined. Since this is the case of a restart, the power-down signal PD is at a high level and the system advances to step S15.

In step S15, the CPU 11 issues a self-refresh start command to the DRAM control circuit 15. At time T11, the DRAM control circuit 15 outputs a clock signal SDCLKI, a clock control signal CKEI, a chip select signal CSI, a row address select signal RASI and a column address select signal CASI at a low level, and also outputs a write control signal WEI and data output mask signals DQMI3 to DQMI0 at a high level, on the basis of the self-refresh start command.

In step S16, the CPU 11 supplies a power-saving mode release command to the power control circuit 30. At time T12, the power-down signal PD generated from the power control circuit 30 thereby becomes a low level, and the output-fixing circuit 20 outputs control signals sent from the DRAM control circuit 15 to the SDRAM 40, instead of the fixed control signals. However, since the control signals sent from the DRAM control circuit 15 at this time are at levels that command self-refresh operation, the self-refresh operation of the SDRAM 40 is continued.

In step S17, the CPU 11 issues a self-refresh release command to the DRAM control circuit 15. At time T13, the DRAM control circuit 15 outputs a clock control signal CKEI at a low level, and outputs a chip select signal CSI, a row address select signal RASI, a column address select signal CASI, a write control signal WEI, and data output mask signals DQMI3 to DQMI0 at a high level, on the basis of the self-refresh release command. The self-refresh state of the SDRAM 40 is thereby released.

In step S18, the CPU 11 restores the task information saved in the SDRAM 40 to the RAM 13 and other memory. Interrupted application programs are thereby resumed.

As described above, since the semiconductor integrated circuit 8 of the present embodiment has the output-fixing circuit 20 for fixing and outputting the levels of the SDRAM control signals to those levels that command self-refresh operation when a power-down signal PD is generated, the supply of power to the power-controlled block 10 having a wide range of components that includes the CPU 11 and DRAM control circuit 15 during the power-saving mode can be completely stopped. Thus, power consumption while system operation is suspended can be considerably reduced.

Since the content of the SDRAM 40 is retained during the power-saving mode, and the state of the suspended tasks is held unchanged in the SDRAM 40, the application programs can be resumed by switching on the power supply again even if the supply of power to the CPU 11 and other components has been stopped.

Furthermore, the state of the tasks in the RAM 13 and other memory can be rapidly saved in (or restored from) the SDRAM 40 when entering (or returning from) the power-saving mode, and therefore, entering (or returning from) the power-saving mode can be carried out at high(er) speed and with low(er) cost in comparison with the case in which flash memory, hard disk, or other secondary storage device is used.

The present invention is not limited to the above-described embodiment, and various modifications and changes may be made without departing from the spirit and scope of the invention. Following are examples of such modifications.

(1) SDRAM is described as an example of DRAM in the above description, but the present invention can be applied in the same manner to conventional asynchronous DRAM and EDO-DRAM. However, since the type and number of control signals and the signal levels that command self-refresh operation are different depending on the type of DRAM, the configuration of the output-fixing circuit 20 may be modified in accordance with the specification of the DRAM to be used.

In the case of EDO-DRAM, for example, a row address select signal RAS, a column address select signal CAS, a write control signal WE, and an output control signal OE are used as the control signals. During self-refresh operation, the row address select signal RAS and column address select signal CAS are set to a low level, and the write control signal WE and output control signal OE are set to a high level.

(2) The scope of the power-controlled block 10 is merely an example, and it may be changed depending upon the system in which the power-controlled block is included.

(3) The power control circuit 30 is connected to the CPU 11 by way of the system bus 16 in FIG. 1, but it may be connected to the CPU 11 by way of the I/O device 14.

(4) The supply of power to the power-controlled block 10 is controlled by sending a power control signal POW to the power-controlled block 10 in the above described embodiment, but a switch may be disposed between the power-controlled block 10 and a power circuit (not shown), and the switch can be turned on and off using the power control signal POW.

This application is based on a Japanese Patent Application No. 2004-178781 filed on Jun. 16, 2004 and the entire disclosure thereof is incorporated herein by reference.

1. A semiconductor integrated circuit comprising:
a dynamic random access memory to which a self-refresh operation can be commanded using a first control signal;
a power-controlled block that includes a central processing unit, and a memory control circuit for controlling the dynamic random access memory;
a power control circuit for outputting a power-down signal and stopping supply of power to the power-controlled block when a command to enter a power-saving mode is issued to the power control circuit from the central processing unit, and for starting the supply of power to the power-controlled block and stopping the output of the power-down signal when a restart signal is provided from outside during output of the power-down signal; and
an output-fixing circuit connected between the memory control circuit and the dynamic random access memory, for directly supplying to the dynamic random access memory a second control signal generated from the memory control circuit when the power-down signal is not being generated, and, when the power-down signal is being generated, supplying the first control signal commanding a self-refresh operation to the dynamic random access memory without regard to the second control signal generated from the memory control circuit.

2. The semiconductor integrated circuit according to claim 1, wherein the dynamic random access memory is an SDRAM, asynchronous DRAM or EDO-DRAM.

3. The semiconductor integrated circuit according to claim 1, wherein the power-controlled block further a read-only memory for storing a program, such as OS, executed by the CPU.

4. The semiconductor integrated circuit according to claim 1, wherein the power-controlled block further a random-access-memory for performing reading and writing at high speed.

5. A power-saving control method for a semiconductor integrated circuit,
the semiconductor integrated circuit including
a dynamic random access memory to which a self-refresh operation is commanded using a first control signal,
a power-controlled block that has a central processing unit and a memory control circuit for controlling the dynamic random access memory,
a power control circuit for controlling supply of power to the power-controlled block and outputting a power-down signal when the power supply to the power-controlled block has been stopped, and for stopping the output of the power-down signal when an instruction has been issued by the central processing unit, and
an output-fixing circuit for outputting the first control signal for commanding a self-refresh operation to the dynamic random access memory when the power-down signal is being generated,
said power-saving control method comprising:
a startup routine for starting the supply of power to the power-controlled block, and releasing a reset state of the power-controlled block to start operation when the reset state of the power control circuit is released;
a determination routine for determining the state of the power-down signal when the supply of power to the power-controlled block has been started, starting up an application program if the power-down signal is not being generated, and issuing a self-refresh start command of the dynamic random access memory to the memory control circuit if the power-down signal is being generated;
a resume routine for stopping the output of the power-down signal from the power control circuit, and issuing a command for releasing the self-refresh operation of the dynamic random access memory to the memory control circuit to resume the application program, subsequent to the output of the self-refresh start command in the determination routine;
a stop routine for issuing a self-refresh start command of the dynamic random access memory to the memory control circuit and instructing the power control circuit to stop supplying power to the power-controlled block when processing of the application program has been interrupted; and
a restart routine for resuming the supply of power to the power-controlled block in accordance with an externally provided restart signal, and releasing the reset state of the power-controlled block to start operation when the supply of power to the power-controlled block is stopped.

6. The power-saving control method according to claim 5, wherein the dynamic random access memory is an SDRAM, asynchronous DRAM or EDO-DRAM.

7. The power-saving control method according to claim 5, wherein the power-controlled block further a read-only memory for storing a program, such as OS, executed by the CPU.

8. The power-saving control method according to claim 5, wherein the power-controlled block further a random-access-memory for performing reading and writing at high speed.

9. A semiconductor integrated circuit comprising:
a dynamic random access memory which operates in a normal mode in response to a first control signal and in a standby mode in response to a second control signal;
a power-controlled block that includes a dynamic random access memory controller, wherein the dynamic random access memory controller issues the first control signal to the dynamic random access memory when a power-save mode is not entered;
a power control circuit for stopping supply of power to the power-controlled block when the power-saving mode is entered, and for starting the supply of power to the power-controlled block when the power-saving mode is released; and
a circuit for issuing the second control signal to the dynamic random access memory when the power save mode is entered.

10. The semiconductor integrated circuit according to claim 9, wherein the standby mode is a self-refresh mode.

11. The semiconductor integrated circuit according to claim 9, wherein the power-controlled block also includes a central processing unit for commanding the power-saving mode.

12. The semiconductor integrated circuit according to claim 9, wherein the dynamic random access memory is an SDRAM, asynchronous DRAM or EDO-DRAM.

13. The semiconductor integrated circuit according to claim 9, wherein the power-controlled block further a read-only memory for storing a program, such as OS, executed by the CPU.

14. The semiconductor integrated circuit according to claim 9, wherein the power-controlled block further a random-access-memory for performing reading and writing at high speed.
